(19) United States
(12) Patent Application Publication
(10) Pub. No.: US 2019/0261617 A1
(43) Pub. Date: Aug. 29, 2019

(54) PARASITIC ARTHROPOD MITIGATION DEVICE AND METHOD OF USE THEREOF

(71) Applicants: Jason A. Dean, Kirkville, NY (US); Joseph B. Milstein, Brookline, MA (US)

(72) Inventors: Jason A. Dean, Kirkville, NY (US); Joseph B. Milstein, Brookline, MA (US)

(21) Appl. No.: 16/405,577

(22) Filed: May 7, 2019

Related U.S. Application Data
(63) Continuation-in-part of application No. 16/149,022, filed on Oct. 1, 2018.
(60) Provisional application No. 62/606,623, filed on Sep. 30, 2017.
(60) Provisional application No. 62/683,558, filed on Jun. 11, 2018.

(51) Int. Cl. A01M 3/00

(52) U.S. Cl. CPC A01M 3/005; A01M 2200/012; A01M 2200/011

(57) ABSTRACT

A method and apparatus for the collection of parasitic arthropods. In one specific example, the parasitic arthropod is a tick, which prefers to cling to the tops of foliage, while waiting for a passing host. The apparatus collects the tick. In one example the apparatus is a roller that includes a cylindrical carrier that is covered with a cloth-like material designed to have a tick attach itself thereto, so that when the roller is passed over a surface where ticks are believed to be present, the ticks attach to the roller. The cloth-like cover material is disposable, as is the cylindrical carrier. The disposable cover material may be conveniently disposed in a refuse container. An advantage of the invention is the mitigation of ticks and the diseases, such as Lyme disease, that the ticks may be carrying, without exposing a user to chemical insecticides.

### CROSS-REFERENCE TO RELATED APPLICATIONS

This application is a Continuation-in-Part of co-pending U.S. patent application Ser. No. 16/149,022 filed on Monday, Oct. 1, 2018 and claims priority to and the benefit thereof, which application claims priority to and the benefit of then co-pending U.S. provisional patent application Ser. No. 62/606,623, filed Sep. 30, 2017, and priority to and the benefit of then co-pending U.S. provisional patent application Ser. No. 62/683,558, filed Jun. 11, 2018, each of which applications is incorporated herein by reference in its entirety.

### FIELD OF THE INVENTION

The invention relates to mitigation of arthropods in general and particularly to systems and methods for mitigating arthropods that do not require the use of chemical insecticides.

### BACKGROUND OF THE INVENTION

The Centers for Disease Control (CDC) has recently reported that illnesses from mosquito, tick, and flea bites have tripled in the U.S., with more than 640,000 cases reported during the 13 years from 2004 through 2016. Nine new germs spread by mosquitoes and ticks were discovered or introduced into the United States during this time. See “Illnesses on the Rise” Vital Signs, CDC News Release dated May 1, 2018, copy appended hereto.

This is CDC's first summary collectively examining data trends for all nationally notifiable diseases caused by the bite of an infected mosquito, tick, or flea. It provides detailed information on the growing burden of mosquito-borne and tickborne illnesses in the U.S.

Zika, West Nile, Lyme, and chikungunya—a growing list of diseases caused by the bite of an infected mosquito, tick, or flea—have confronted the U.S. in recent years, making a lot of people sick.

In the United States, some ticks carry pathogens that can cause human disease, including:

Anaplasmosis is transmitted to humans by tick bites primarily from the blacklegged tick (Ixodes scapularis) in the northeastern and upper midwestern U.S. and the western blacklegged tick (Ixodes pacificus) along the Pacific coast.

Babesiosis is caused by microscopic parasites that infect red blood cells. Most human cases of babesiosis in the U.S. are caused by Babesia microti. Babesia microti is transmitted by the blacklegged tick (Ixodes scapularis) and is found primarily in the northeast and upper midwest.

Borrelia mayonii infection has recently been described as a cause of illness in the upper midwestern United States. It has been found in blacklegged ticks (Ixodes scapularis) in Minnesota and Wisconsin. Borrelia mayonii is a new species and is the only species besides B. burgdorferi known to cause Lyme disease in North America.

Borrelia miyamotoi infection has recently been described as a cause of illness in the U.S. It is transmitted by the blacklegged tick (Ixodes scapularis) and has a range similar to that of Lyme disease.

Bourbon virus infection has been identified in a limited number patients in the Midwest and southern United States. At this time, we do not know if the virus might be found in other areas of the United States.

Colorado tick fever is caused by a virus transmitted by the Rocky Mountain wood tick (Dermacentor andersoni). It occurs in the the Rocky Mountain states at elevations of 4,000 to 10,500 feet.

Ehrlichiosis is transmitted to humans by the lone star tick (Ambylomma americanum), found primarily in the southcentral and eastern U.S.

Heartland virus cases have been identified in the Midwestern and southern United States. Studies suggest that Lone Star ticks can transmit the virus. It is unknown if the virus may be found in other areas of the U.S.

Lyme disease is transmitted by the blacklegged tick (Ixodes scapularis) in the north eastern U.S. and upper midwestern U.S. and the western blacklegged tick (Ixodes pacificus) along the Pacific coast.

Powassan disease is transmitted by the blacklegged tick (Ixodes scapularis) and the groundhog tick (Ixodes cookei). Cases have been reported primarily from northeastern states and the Great Lakes region.

Rickettsia parkeri rickettsiosis is transmitted to humans by the Gulf Coast tick (Amblyomma maculatum).

Rocky Mountain spotted fever (RMSF) is transmitted by the American dog tick (Dermacentor variabilis), Rocky Mountain wood tick (Dermacentor andersoni), and the brown dog tick (Rhipicephalus sangunineus) in the U.S. The brown dog tick and other tick species are associated with RMSF in Central and South America.

STARI (Southern tick-associated rash illness) is transmitted via bites from the lone star tick (Ambylomma americanum), found in the southeastern and eastern U.S.

Tickborne relapsing fever (TBRF) is transmitted to humans through the bite of infected soft ticks. TBRF has been reported in 15 states: Arizona, California, Colorado, Idaho, Kansas, Montana, Nevada, New Mexico, Ohio, Oklahoma, Oregon, Texas, Utah, Washington, and Wyoming and is associated with sleeping in rustic cabins and vacation homes.

Tularemia is transmitted to humans by the dog tick (Dermacentor variabilis), the wood tick (Dermacentor andersoni), and the lone star tick (Amblyomma americanum). Tularemia occurs throughout the U.S.

364D rickettsiosis (Rickettsia phillipi, proposed) is transmitted to humans by the Pacific Coast tick (Dermacentor occidentalis ticks). This is a new disease that has been found in California.

Mosquitos are also known to carry diseases. Examples are the Zika virus, West Nile virus; dengue fever and chikungunya.

The only flea-borne disease in the CDC report is plague, the bacterium responsible for the medieval Black Death. It remains rare but persistent: Between two and 17 cases were reported from 2004 to 2016, mostly in the Southwest. The infection can be cured with antibiotics.

The Asian long-horned tick, Haemaphysalis longicornis, is spreading rapidly along the Eastern Seaboard. It has been found in seven states and in the heavily populated suburbs of New York City.

In the prior art, it is known to use various chemical agents either to repel such insects, or to attempt to kill or otherwise render insects harmless. However, many such chemicals pose their own risks to health. In some cases, such applications require people and pets to remain indoors while the chemicals are applied, often by spraying from vehicles, helicopters or airplanes. Use of chemicals also adds costs, which may be significant. Examples of such chemicals are N, N-Diethyl-meta-toluamide (known as DEET), Icaridin, also known as picaridin, and/or ethyl butylacetylaminopropionate (also known as IR3535).

In some instances outdoor workers have been suffering from tick exposure while performing their duties in the field. It is not uncommon that such workers wear dog collars around their wrists and ankles as a method to ward off ticks. Exposure to these chemicals is extremely ill advised, as flea and tick collars commonly consist of Propoxur and Tetrachlorvinphos, which are pesticides that can affect the nervous system in both pets and humans.

Propoxur, also known as 2-Isopropoxyphenyl-N-methylcarbamate, is a carbamate non-systemic insecticide. According to the EPA, Propoxur is also known to be a carcinogen. Propoxur is highly toxic to many bird species, but its toxicity varies by the species. It is moderately to slightly toxic to fish and other aquatic species. Propoxur is highly toxic to honeybees.

Tetrachlorvinphos, also known as (Z)-2-Chloro-1-(2,4,5-trichlorophenyOvinyl dimethyl phosphate, is an organophosphate insecticide used to kill fleas and ticks. Exposure to Tetrachlorvinphos is believed to cause one or more of increased perspiration, nausea, lachrymation, salivation, blurred vision, diarrhea, pulmonary edema, respiratory embarrassment and convulsions. The chemical material may be absorbed through the skin and is a lachrymator. It is a cholinesterase inhibitor and is a positive animal carcinogen.

Permethrin, also identified by the chemical formula C₂₁H₂₀Cl₂O₃, is used as an insecticide, as an insect repellent or insect screen, as a personal protective measure, such as a cloth impregnant, notably in mosquito nets and field wear, and in pet flea preventive collars or treatment. Permethrin is often used in combination with piperonyl butoxide, also known as 5-[2-(2-butoxyethoxy)ethoxymethyl]-6-propyl-1,3-benzodioxole, to enhance its effectiveness. In agriculture, permethrin is mainly used on cotton, wheat, maize, and alfalfa crops. Its use is controversial because, as a broad-spectrum chemical, it kills indiscriminately; as well as the intended pests, it can harm beneficial insects, including honey bees, and aquatic life.

There is a need for systems and methods to render such disease carrying arthropods, particularly ticks, mosquitos and fleas, harmless, or to mitigate them by removal from a given area, without the expense and difficulties associated with chemical methods.

### SUMMARY OF THE INVENTION

According to one aspect, the invention features an arthropod mitigation device, comprising: a handle; and a disposable section configured to be removably attached to the handle, comprising; a carrier section having a substantially cylindrical surface; a cover section configured to be applied to the carrier section, the cover section when so applied to the carrier section configured to provide a substantially cylindrical surface that is attractive to an arthropod; the arthropod mitigation device configured to be operated by a user so as to traverse by rolling a region of interest believed to harbor an arthropod, and to mitigate the arthropod therefrom by without the application of a chemical insecticide.

In one embodiment, the arthropod is one of a tick a mosquito, and a flea.

In another embodiment, the cover section is provided in a sleeve configuration.

In yet another embodiment, the cover section is provided in a sheet configuration.

In still another embodiment, the cover section in sheet configuration comprises an attachment structure.

In a further embodiment, the attachment structure is a selected from the group consisting of a hook and eye fastener, an adhesive, and an elastic band.

In yet a further embodiment, the carrier section is configured to expand radially when subjected to a pressure.

In an additional embodiment, the pressure is selected from the group of a mechanical pressure, a pneumatic pressure and a hydraulic pressure.

According to another aspect, the invention relates to a method of mitigating arthropods, comprising the steps of: providing an arthropod mitigation device, comprising: a handle; and a disposable section configured to be removably attached to the handle, comprising; a carrier section having a substantially cylindrical surface; a cover section configured to be applied to the carrier section, the cover section when so applied to the carrier section configured to provide a substantially cylindrical surface that is attractive to an arthropod; the arthropod mitigation device configured to be operated by a user so as to traverse by rolling a region of interest believed to harbor an arthropod, and to mitigate the arthropod therefrom by without the application of a chemical insecticide; and rolling the arthropod mitigation device over the region of interest; collecting the arthropod; and disposing of at least the cover section of the disposable section; thereby mitigating arthropods from the area of interest.

In one embodiment, the method further comprises the step of disposing of at least the cover section of the disposable section by placing at least the cover section in a refuse container.

In another embodiment, the refuse container is selected from a zip closure bag and a garbage bag.

In yet another embodiment, the refuse container comprises an insecticide.

In still another embodiment, the arthropod is at least one of a tick a mosquito, and a flea.

According to another aspect, the invention relates to a method of providing an arthropod mitigation device in kit form, comprising: a handle; a disposable section configured to be removably attached to the handle, comprising; a carrier section having a substantially cylindrical surface; and a cover section configured to be applied to the carrier section, the cover section when so applied to the carrier section configured to provide a substantially cylindrical surface that is attractive to an arthropod; the kit when assembled configured provide an arthropod mitigation device configured to be operated by a user so as to traverse by rolling a region of interest believed to harbor an arthropod, and to mitigate the arthropod therefrom by without the application of a chemical insecticide.

In one embodiment, at least two of the handle, the carrier section, and the cover section are provided assembled to each other.

In another embodiment, the cover section is provided in a configuration selected from a sleeve configuration and a sheet configuration.

In yet another embodiment, the cover section in sheet configuration comprises an attachment structure.

In still another embodiment, the attachment structure is a selected from the group consisting of a hook and eye fastener, an adhesive, and an elastic band.

In a further embodiment, the carrier section is configured to expand radially when subjected to a pressure.

In yet a further embodiment, the pressure is selected from the group of a mechanical pressure, a pneumatic pressure and a hydraulic pressure.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 depicts parasitic arthropods, such as ticks, clinging to the tops of foliage, whereby an air in-take line is introduced at or around the same elevation, whereby the parasites are subjected to a “suction” force, designed to exceed the gripping strength of the parasites, resulting in the removal and collection thereof of said parasites.

FIG. 2 depicts the transport of the parasitic arthropods, from initial collection, to transport to a holding tank, via a mechanically generated suction force. The parasites are extracted from the intake air by means of an aqueous medium, whereby the resulting air is then exhausted through an exhaust port.

FIG. 3 depicts the operation of a UVC diode array, designed to emit a low frequency wavelength from varying trajectories.

FIG. 4 depicts a cross sectional view illustrating both the collection tank, and the external shielding tank which limits exposure to the UVC light source. Furthermore, the collection tank possesses reflective interior walls, whereby UVC wavelengths are reflective in varying trajectories, and designed to provide maximum exposure of UVC light.

FIG. 5 is an image of a second embodiment configured as a mechanical roller.

FIG. 6 is an image of the interior structure of the roller illustrated in FIG. 5.

FIG. 7 is an image of the interior structure of the roller illustrated in FIG. 6 covered with a synthetic fiber cover that is configured to allow ticks to become attached thereto.

FIG. 8 is an image of the surface of the synthetic fiber cover with a tick attached thereto.

FIG. 9 is an image of a lawn roller, configured to receive arthropods by means of synthetic fibers.

FIG. 10A is a schematic view of an embodiment of a disposable portion of an arthropod mitigation device according to the invention.

FIG. 10B is a schematic illustration of a carrier section that may expand radially under mechanical pressure.

FIG. 10C is a schematic illustration of a carrier section that may expand radially under pneumatic pressure.

FIG. 11 is a schematic drawing of another embodiment of a disposable portion of an arthropod mitigation device according to the invention.

FIG. 12 is an illustration of an embodiment of an arthropod mitigation device according to principles of the invention.

FIG. 13A is an illustration of another embodiment of an arthropod mitigation device according to principles of the invention.

FIG. 13B is an illustration the disassembly of the arthropod mitigation device of FIG. 13A.

FIG. 13C is an illustration of the mechanical relationship among parts of the arthropod mitigation device of FIG. 13A.

FIG. 14 is an illustration of still another embodiment of an arthropod mitigation device according to principles of the invention.

FIG. 15 is an image of a Ziploc® zip closure bag.

FIG. 16 is an image of a 13 gallon kitchen garbage bag.

### DETAILED DESCRIPTION

It would be advantageous to provide a low-cost solution for protection of people who spend time out of doors, such as outdoor workers and others, by the collection and disposal of ticks, using an arthropod collection device that is portable, that does not rely upon electricity or fuel to operate, and that does not expose the user of the device to dangerous chemicals.

In general, the invention involves providing apparatus and methods by which arthropods are collected, and can be removed from a region of interest, such as a lawn, a playing field, a walking path or trail, and then the arthropods can be neutralized, all of which is accomplished without the deliberate application of hazardous chemicals to the region of interest. One method includes passing a mechanism that may comprise a surface that arthropods preferentially attach themselves to, or a mechanism that provides suction, or both, over the region of interest, allowing the arthropods to attach themselves to the surface or be collected by the suction force, removing the arthropods from the region of interest, and subjecting the arthropods to a neutralizing field such as electromagnetic radiation (UV light, for example).

In some instances, it may be useful to collect the arthropods in a region so that the number present is temporarily diminished so as to reduce the chance that the arthropods will attach themselves to a person who will be in that location for a short period, such a few hours or a work day.

According to principles of the invention, upon arrival at a location of interest, outdoor workers prepare the arthropod collection device comprising a roller with a disposable cover configured to capture arthropods, for example “questing” ticks, the disposable cover configured to be disposed of immediately after its use. In some embodiments, the arthropod collection device is an inexpensive apparatus which includes a disposable portion that comprises a surface to which the arthropods preferentially attach themselves. In some embodiments, after it has been used to collect arthropods, the disposable cover portion can be conveniently separated from the roller, enclosed in a refuse container and later disposed of. According to principles of the invention, the outdoor worker uses the arthropod collection device comprising the roller with the disposable cover to sweep an area of interest to mitigate arthropods prior to engaging in work activities, or other uses, of the area of interest. Upon completion of the sweeping of the area, at least the disposable cover of the arthropod collection device is safely secured in a refuse container designed to encapsulate the disposable cover to contain therein the ticks caught in, or which have attached themselves to, the disposable cover. In one embodiment, the refuse container is designed for a single use. A used disposable cover, sealed within a refuse container, may be discarded at a convenient time, such as at the end of a work day, and at a convenient location, such as at a designated collection location, or at a local refuse bin, such as a garbage can or a dumpster, that the outdoor worker has permission to utilize.

Among the benefits and advantages of utilizing the portable devices of the invention are a reduction of the exposure of outdoor workers to disease-bearing arthropods, such as exposure to ticks carrying Lyme disease, as well as reduction of undesirable chemical exposure from application of chemicals intended to ward off arthropods, such as flea and tick collars. An additional benefit that is expected is the reduction in actual incidents of disease, such as Lyme disease, by reducing the incidence of exposure to the disease carriers.

In some embodiments, the disposable portion may be disposed of without treating the collected arthropods. In some embodiments, the refuse container can be a plastic bag into which the disposable portion of the apparatus is inserted, after which insertion the plastic bag is sealed. The sealed refuse container can then be transported to a waste collection location without exposing humans to the arthropods. For example, in one embodiment the refuse container is a plastic bag, such as a 13 gallon bag such as is used to collect kitchen refuse can be sealed by twisting the open end to form a neck and tying the neck shut with a cord. In another embodiment, the refuse container is a zip-lock plastic bag.

In some embodiments, the refuse container may optionally have disposed internally therein a pesticide designed to kill a collected arthropod. In one embodiment, the pesticide is at least one of permethrin, Propoxur and Tetrachlorvinphos. Because the pesticide is disposed within the refuse container, the chance that the outdoor worker would be exposed to the pesticide is minimized, and the contamination of the local outdoor environment with the pesticide is reduced. That reduction of use of the pesticide is advantageous if the area in which the arthropods have been deliberately reduced is used by others, for example children at play, or people recreating, for example, picnicking on a blanket on the grass in a park. Another advantage is that the pesticide may kill arthropods placed inside the refuse container even if the refuse container is not hermetically sealed, which otherwise might allow arthropods to exit by way of the less than hermetic seal.

The arthropods may be collected for further analysis by suitable laboratories, for example to count how many (or what percentage of) arthropods are infected with, or are carriers of, various diseases. This can assist health monitoring agencies to determine where (geographically) such infected arthropods are present, and how severe the danger from specific types of arthropods (and the diseases that they are carrying) may be at a given time.

In one embodiment, the present invention comprises an electromechanical device, designed to provide intake pressure, or suction, of parasitic arthropods from grasses, and to collect said arthropods in an aqueous medium, whereby said arthropods are subjected to irradiation, such as from a UVC light source. Said collection system is designed to extract parasitic arthropods from grasses, and to neutralize the harmful bacteria in which they may carry, such as Lyme Borreliosis, Rocky Mountain spotted fever, anaplasmosis, ehrlichiosis, Powassan virus, and or babesiosis; all of which are subject to neutralization through the repeated exposure to an irradiation type light source.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In a first embodiment, a parasitic arthropod collection system, apparatuses, and methods for collecting and neutralizing parasitic arthropods that carry harmful blood-borne pathogens are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or descriptions below.

### First Embodiment

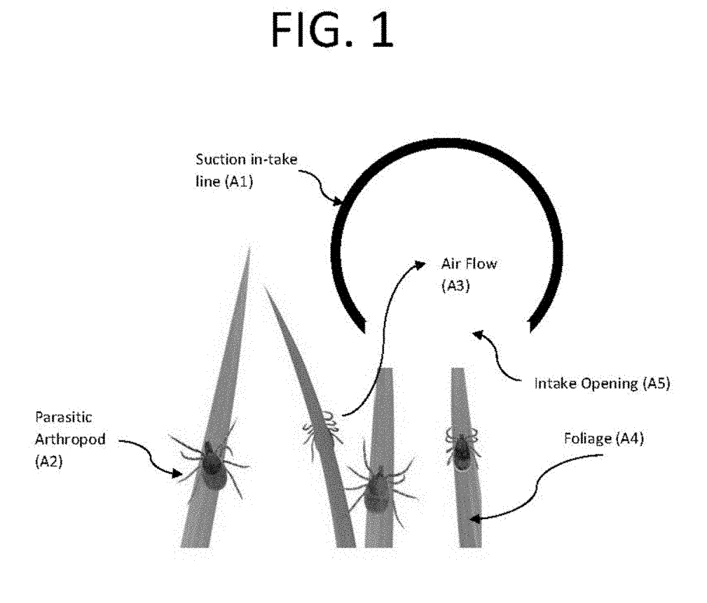

The first embodiment will now be described by referencing the appended figures representing preferred embodiments. FIG. 1 depicts the initial collection of parasitic arthropods. FIG. 1-A1 depicts an intake collection tube, pressurized (or depressurized) so as to generate a suction force (FIG. 1-A3) at its opening (FIG. 1-A5), and designed to remove parasitic arthropods (FIG. 1-A2) from foliage (FIG. 1-A4). The intake is designed to be adjustable in elevation, thereby providing a means to align said intake with the height of the source foliage (FIG. 1-A4).

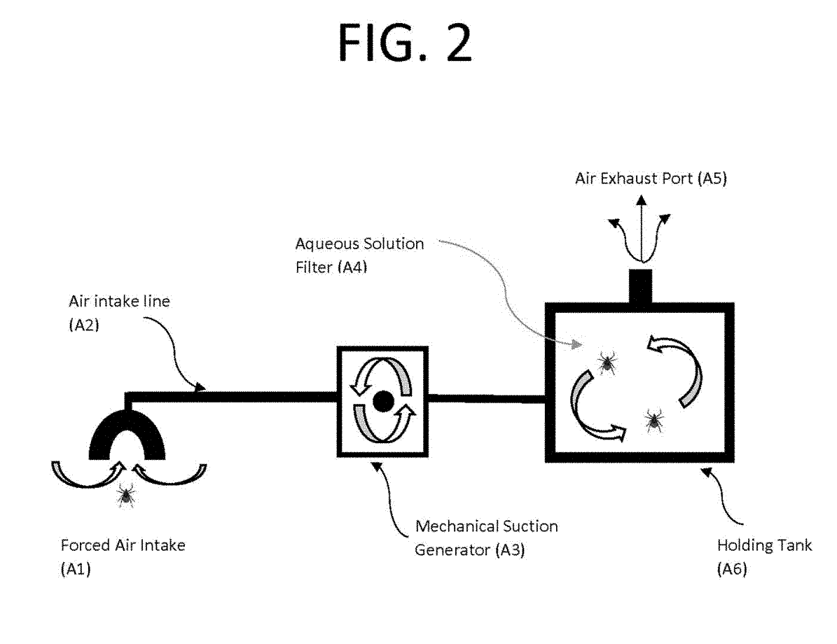

FIG. 2 depicts the processes involved in the collection of parasitic arthropods. The suction force utilized to generate a collective force is generated by mechanical means (FIG. 2-A3), which in turn generates a negative pressure at the intake (FIG. 2-A1). Parasitic arthropods are pulled from the tops of foliage, and are drawn along an intake line (FIG. 2-A2), and fed to a holding tank (FIG. 2-A6). Pressurized air collected in the holding tank (FIG. 2-A6), is then exhausted through a port (FIG. 2-A5).

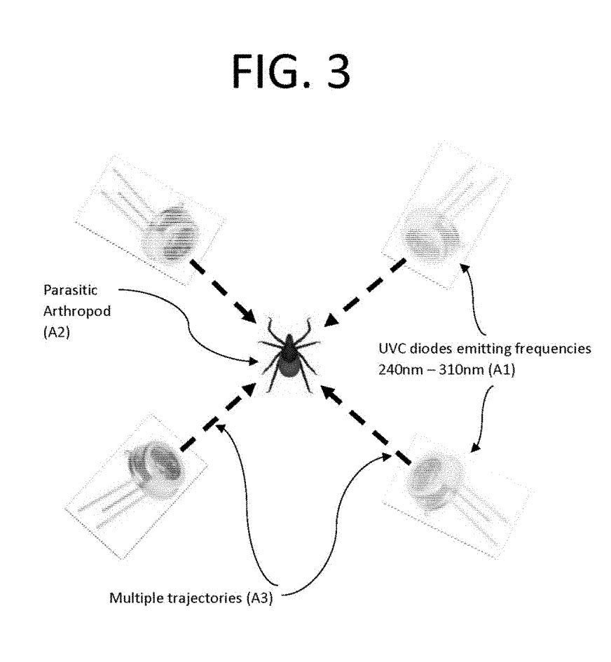

FIG. 3 depicts the primary irradiation source, which involves an array of UVC diodes (FIG. 3-A1), positioned to irradiate parasitic arthropods (FIG. 3-A2) from a multitude of trajectories (FIG. 3-A3). As a result, maximum exposure of UVC radiation (FIG. 3-A1) is achieved.

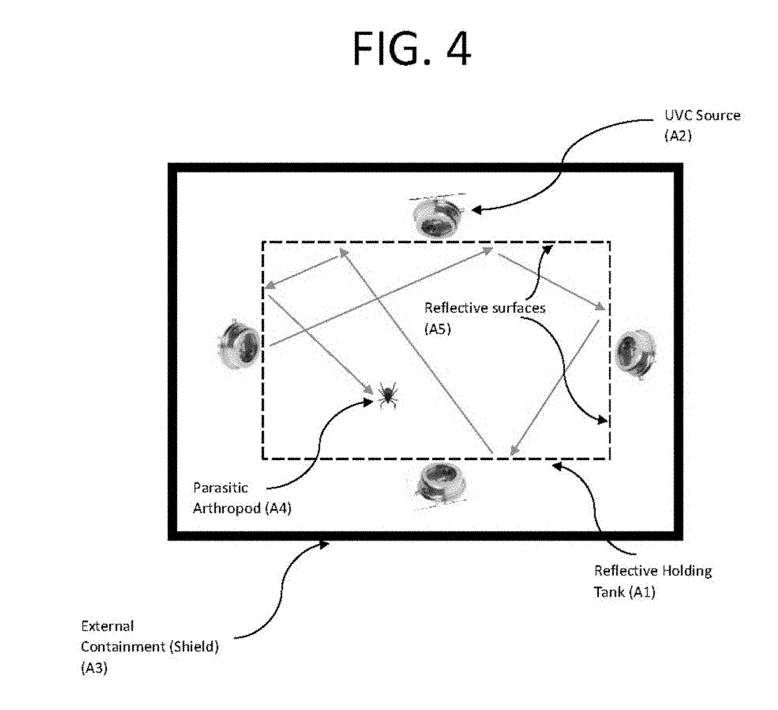

FIG. 4 depicts the composition of the external holding tank (FIG. 4-A3). The external holding tank (FIG. 4-A3) is designed to encapsulate an internal holding tank (FIG. 4-A1), which is designed to hold an aqueous filtering medium, and to provide maximum exposure to UVC radiation (FIG. 4-A2) by means of reflective interior walls (FIG. 4-A5).

The first embodiment of the invention may be provided as a device that attaches to a mechanical object such as a riding mower. In the alternative, a smaller model may be provided in the form of a “man pack” that can be worn by a user, with a hose and a vacuum wand as an intake collection tube.

### Second Embodiment

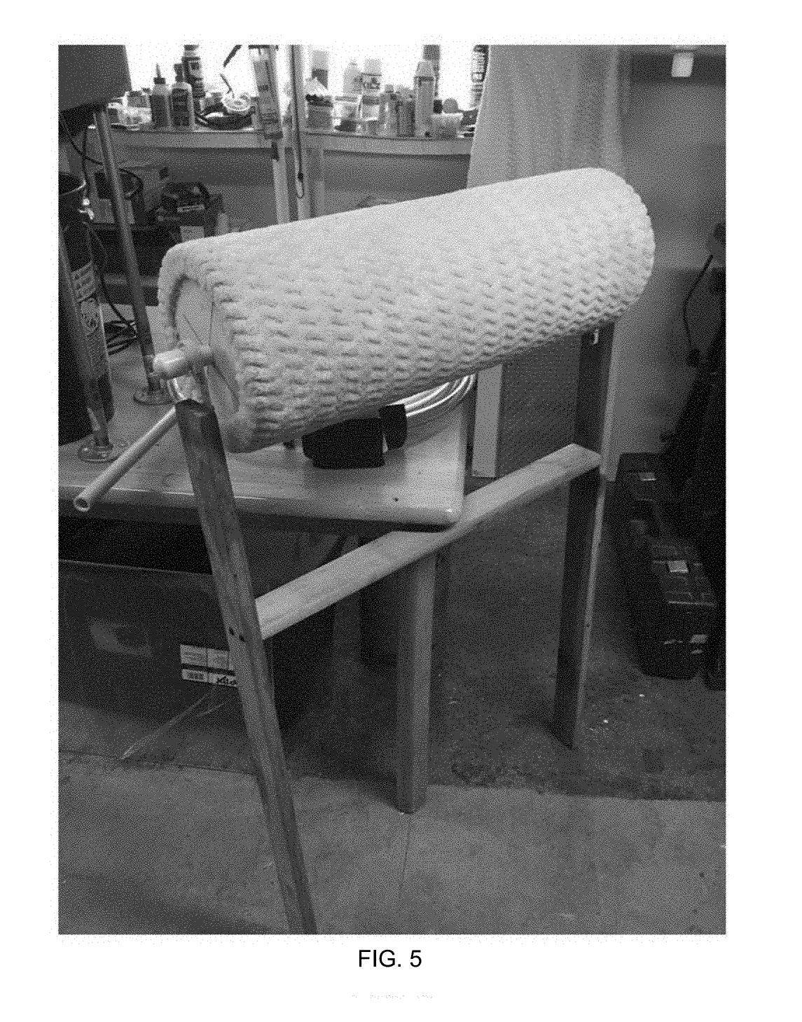

FIG. 5 is an image of a second embodiment configured as a mechanical roller.

The embodiment illustrated in FIG. 5 may be operated by being attached to a mobile device such as a riding lawn mower, or may be operated by being pushed by a human operator, in a manner similar to a push mower.

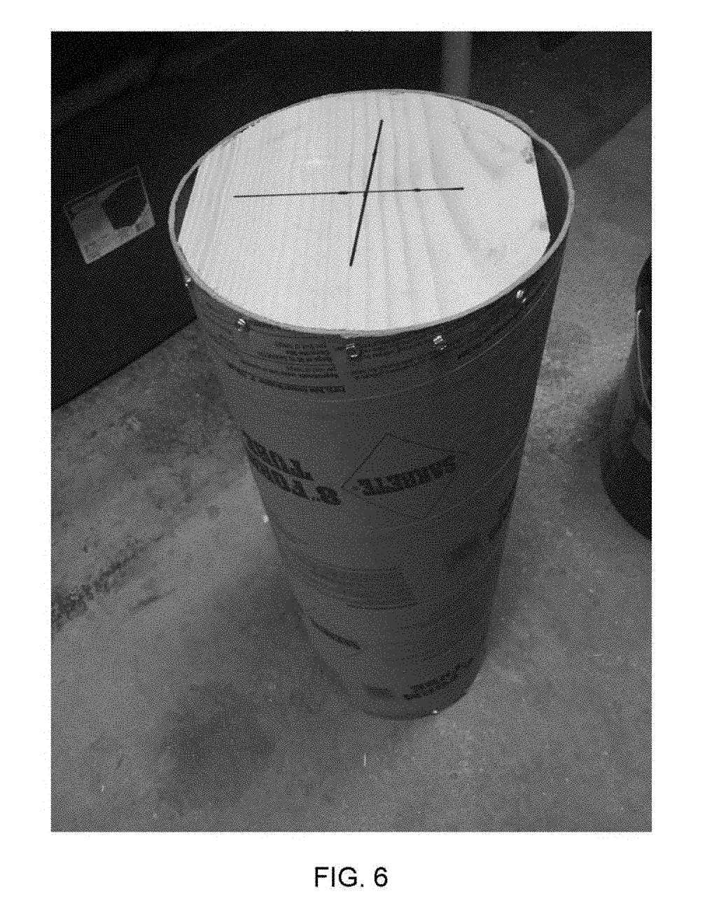

FIG. 6 is an image of the interior structure of the roller illustrated in FIG. 5.

The device of the second embodiment has an interior structure in the form of a cylinder (which may be hollow or may be solid), and having a pair of end plates that can support a rotational structure aligned along the central axis of the cylinder. The rotational structure may be an axle that extends past each end of the cylinder, and may be constructed of a single axle extending from an exterior surface of the first end plate to an exterior surface of the second end plate, or may be two rotational structures, each one attached to a respective exterior surface of each end plate.

The device of the second embodiment has a handle structure that allows each rotational structure, and the attached cylinder, to rotate while the handle structure is used to propel the roller over a surface, such as by way of example, a grass lawn. The roller can be propelled by a human, or by a mechanical device such as a riding mower.

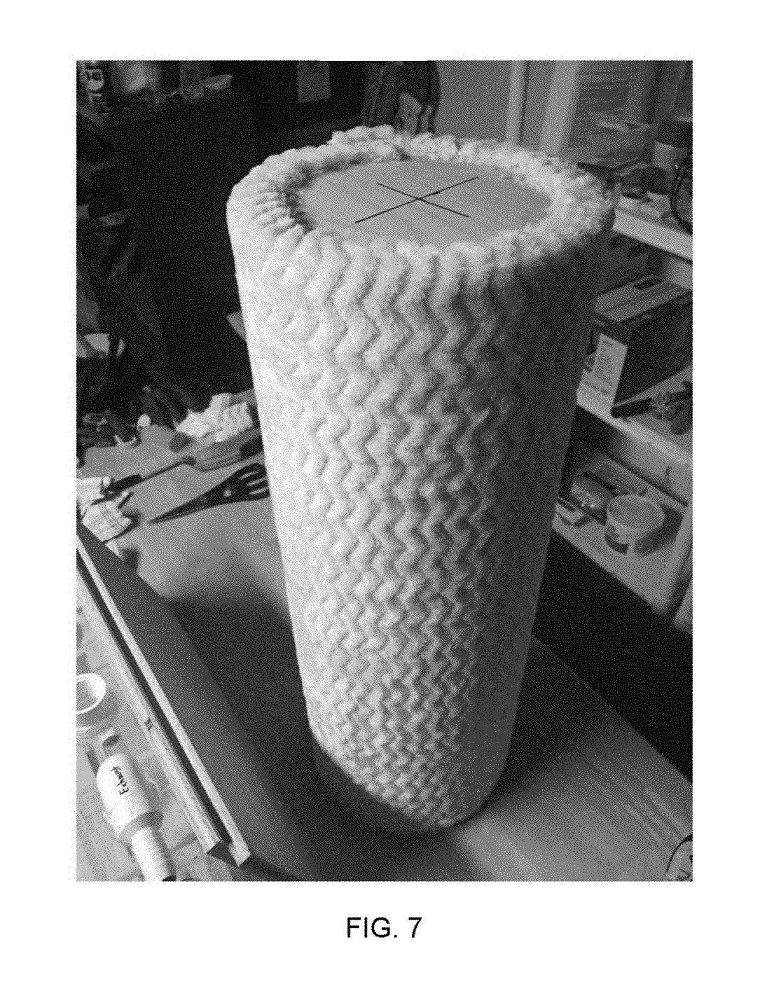

FIG. 7 is an image of the interior structure of the roller illustrated in FIG. 6 covered with a synthetic fiber cover that is configured to allow ticks to become attached thereto.

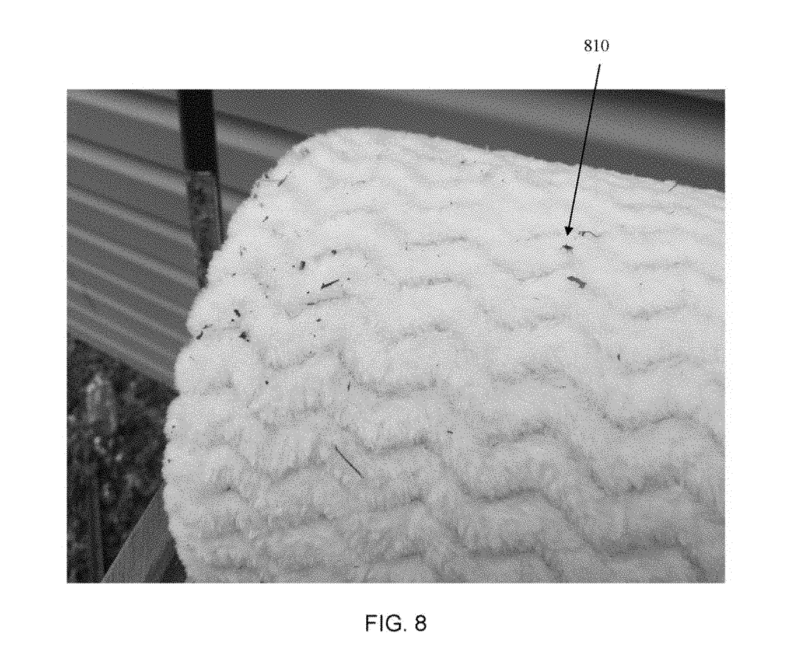

FIG. 8 is an image of the surface of the synthetic fiber cover with a tick 810 attached thereto.

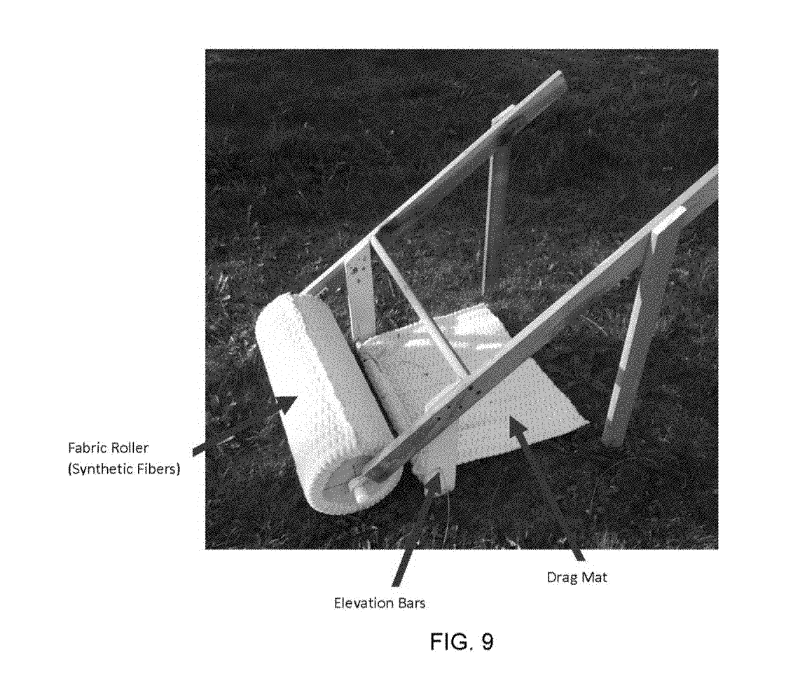

FIG. 9 is an image of a lawn roller, configured to receive arthropods by means of synthetic fibers. The fibers are configured to mimic the characteristics of a host preferred by arthropods. The roller is configured to rotate on top of grass or grasses, so that arthropods will adhere to the synthetic fibers. The rotating action of the roller is designed to prevent the snagging of the synthetic material upon potential debris in the grass.

The roller of FIG. 9 depicts a combination of both roller and drag mat. The combination of both roller and drag mat provide a dual function, so that arthropods that are not successfully snared by the roller are exposed to a secondary entrapment surface. The elevation bars of FIG. 9 provide a way to elevate the mechanism to facilitate the cleaning of both the roller and drag mat. The mechanism is configured to be positioned onto its gripping handles to provide the necessary elevation for cleaning.

Either the roller embodiment such as illustrated in FIG. 5, or the embodiment that incorporates the combination of the roller and the drag mat as illustrated in FIG. 9, collectively described as “the apparatus”, may be propelled by a an animate user (e.g., a person or a work animal) walking behind the apparatus, or by a mechanical device such as a riding mower to which the apparatus is attached.

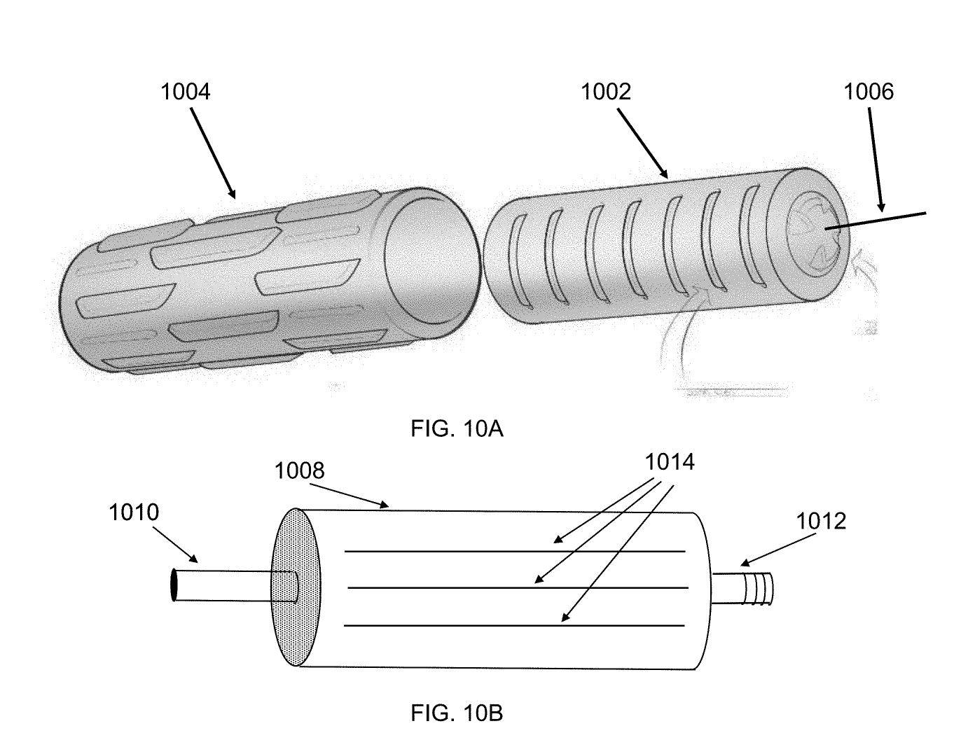

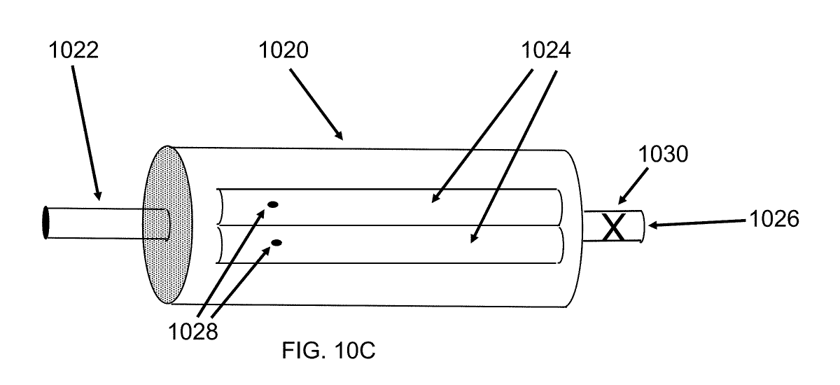

FIG. 10A is a schematic view of an embodiment of a disposable portion of an arthropod mitigation device according to the invention.

The embodiment of the disposable portion of the arthropod mitigation device illustrated in FIG. 10A comprises a carrier section 1002 and a cover section 1004. The carrier section 1002 is preferably constructed of structural material that has the properties of being light in weight, being unlikely to provide a surface that the arthropods of interest quest to (for example a smooth, hard surface), and being amenable to some mechanical deformation when placed under pressure. Examples of such material include common engineering plastics, for example polypropelene. The cover section 1004 is preferably constructed from material that comprises synthetic fibers that are configured to allow ticks to become attached thereto, similar to that illustrated in FIG. 9.

In general, the carrier section 1002 has a substantially cylindrical shape and has a rotation axis 1006 disposed along the cylinder central axis.

In various embodiments, the carrier section 1002 illustrated in FIG. 10A may be made to expand by the application of mechanical pressure, by the application of pneumatic (or gas) pressure, or by the application of hydraulic (or fluid) pressure.

FIG. 10B is a schematic illustration of a carrier section that may expand radially under mechanical pressure.

The carrier section 1008 illustrated in FIG. 10B can be expanded radially by mechanical pressure. When the carrier section 1008 is pressurized, it expands radially so as to form a substantially cylindrical body having an outer surface comprising the cover section 1004. In on embodiment, the carrier section 1008 is hollow with a series of slits 1014 cut in its cylindrical surface, each slit oriented parallel to the rotation axis defined by a shaft-like protrusion 1010 at one end of the carrier section 1008 and a second shaft-like protrusion 1012 at the opposite end of the substantially cylindrical carrier section 1008. At least one of protrusions 1010 and 1012 is free to move axially relative to its respective end of the carrier section 1008, and at least that protrusion is threaded so as to accept a threaded nut. When the nut is tightened against the end of the carrier section 1008, it compresses the carrier section 1008, which then expands radially, as the slits open up under pressure. The cover section 1004 is pushed in to the unpressurized carrier section 1008, which may be of a dimension such that there is clearance between the carrier section 1008 and the cover section 1004 when the carrier section 1008 is not pressurized, and such that there is no clearance between the carrier section 1008 and the cover section 1004 when the carrier section 1008 is pressurized and expanded radially. When assembled as a unit, the carrier section 1008 and the cover section 1004 of FIG. 10 is similar in mechanical function to the roller portion of any of the embodiments illustrated in FIG. 5, FIG. 7 or FIG. 9.

The cover section 1004 preferably is constructed as a sleeve that is approximately as long as the carrier section 1002 or 1008, and that has a diameter slightly larger than the external diameter of the carrier section 1002 or 1008 before the carrier section 1002 or 1008 is subjected to pressure. The sleeve form of the cover section 1004 (which may also be referred to as cover sleeve 1004) may be conveniently slipped over the unpressurized carrier section 1002 or 1008. In an alternative embodiment, the length of the cover section 1004 may be foreshortened, so long as the cover section 1004 presents sufficient surface to effectively collect arthropods.

FIG. 10C is a schematic illustration of a carrier section that may expand under pneumatic pressure.

In FIG. 10C, carrier section 1020 is hollow and has a shaft-like protrusion 1022 at one end of the carrier section 1020 and a second shaft-like protrusion 1026 at the opposite end of the substantially cylindrical carrier section 1020, the two shaft-like protrusions defining a rotation axis at the central axis of cylindrical carrier section 1020. Along the surface of carrier section 1020, there are disposed one or more inflatable structures 1024, which can be similar to the cells of packing material known as “bubble wrap” (that is, a material having one or more pockets made of a thin membrane such as plastic and filled with air). As illustrated in FIG. 10C, only two such inflatable structures 1024 are illustrated. In some embodiments, there are present sufficient numbers of such structures as to cover a circumscribed region of the surface of the cylinder (that is, such inflatable structures 1024 go all the way around the cylindrical carrier 1020). The inflatable structures 1024 are in fluid communication by way of apertures 1028 in the wall of the carrier section 1020 with a valve 1030 situated in one of the shaft-like protrusions, here protrusion 1026. Air pressure may be applied to the internal volumes of carrier section 1020 and each of inflatable structures 1024 by way of valve 1030 to raise the pressure above ambient (e.g., 1 atmosphere) and additionally, the pressure may also be reduced back to ambient by operating valve 1030. In other embodiments, other fluids, such as water, may be used to pressurize the carrier section 1020, especially if one wishes to add weight to the carrier section.

In operation, a carrier section 1020 and a cover section 1004 are assembled by sliding the cover section 1004 on to the unpressurized carrier section 1020, and then raising the internal pressure of the carrier section 1020 by applying pressure from a conventional air compressor (for example, an mechanically operated air pump, an electrically operated tire inflation pump, a hydraulically activated pump, or the like) or from a supply of compressed gas, such as compressed air, compressed nitrogen, or the like.

After the disposable section of the arthropod mitigation device is used, and the disposable cover section 1004 has been exposed to arthropods, the arthropod mitigation device can be disassembled so that the now “contaminated” disposable cover section 1004 may be removed, placed in a refuse container, and disposed of

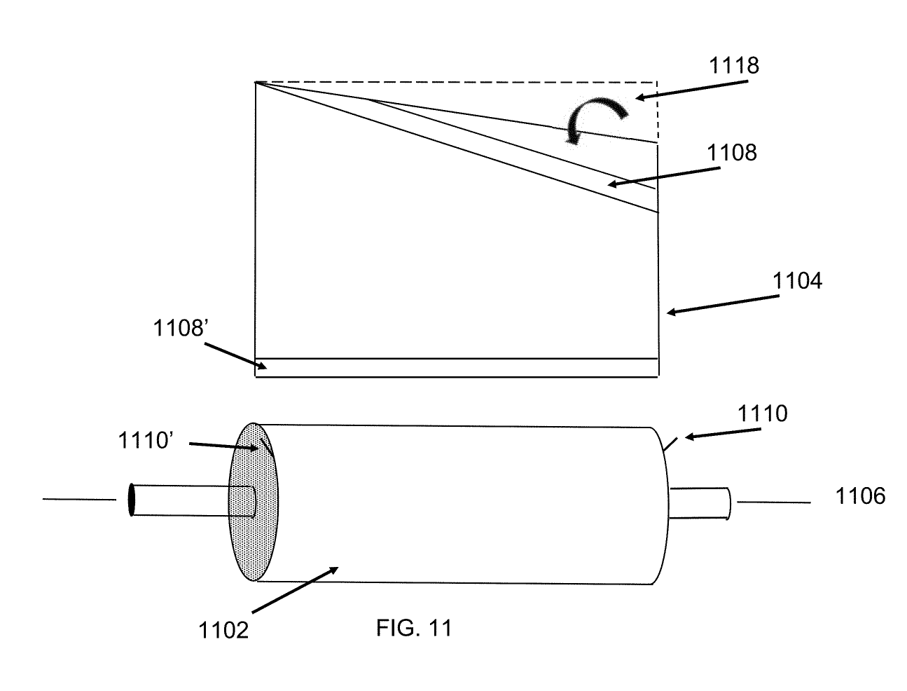

FIG. 11 is a schematic drawing of another embodiment of a disposable portion of an arthropod mitigation device according to the invention.

As illustrated in FIG. 11, the disposable portion of an arthropod mitigation device comprises a roller constructed from a carrier section 1102 and a sheet-type cover section 1104. The carrier section 1102 is a substantially cylindrical body having a rotation axis 1106. As illustrated in FIG. 11, sheet type cover section 1104 is folded (for illustration purposes, designated by the curved arrow) at the upper right-hand corner, to show a stripe of an attachment structure 1108 that is present in one embodiment. The sheet type cover section 1104 is illustrated with a region 1118, illustrated in dashed line, which shows the extent of the upper right corner of type cover section 1104 when not folded down. A second stripe of an attachment structure 1108′, which is shown in one embodiment, is illustrated at the bottom of the sheet type cover section 1108, so that when stripes 1008 and 1108′ overlap, the respective attachment structures connect to each other. In some embodiments, only one of stripes 1008 and 1008′ need be present, for example if the stripe is an adhesive. Both stripes 1008 and 1008′ may be present if they form a hook and eye fastener working together.

The cover section 1104 is provided as a sheet of material that comprises synthetic fibers that are configured to allow ticks to become attached thereto. The sheet of material may be wrapped around the carrier section 1102. Because the cover section 1104 is wrapped around the carrier section 1102, there is in principle no need to expand the carrier section 1102 by the application of pressure so as to capture the cover section 1104. Therefore, in some embodiments, carrier section 1102 is a simple substantially cylindrical structure having a rotation axis at the central axis of the cylinder. Nevertheless, in an alternative embodiment, carrier section 1102 may be provided in a form substantially similar to the carrier sections 1008 and 1020 described above.

In various embodiments of the sheet form, an attachment structure is provided as part of cover sheet 1104 to hold the cover sheet 1104 in place when applied to the carrier section 1102. By way of example, the attachment structure 1108, 1108′ may be any of a hook and eye fastener (similar to Velcro®), an adhesive, or an elastic band such as a rubber band, so that when the sheet of material is applied to the carrier section 1102, it is maintained in place as a cylindrical cover section 1104 exterior to the carrier section 1102. Preferably, the cover sheet 1104 is provided with dimensions sufficient to extend substantially the length of the carrier section 1102, and with a width sufficient to substantially wrap around carrier section 1102 and to overlap one edge of the cover sheet 1104 over another edge thereof (that is, with a width somewhat greater than the circumference of the cylindrical carrier section 1102 so as to permit the overlap of one edge over the other). In an alternative embodiment, either or both of the length of the cover section 1104 may be foreshortened, so long as the cover section 1104 when wrapped around the carrier section 1102 presents sufficient surface to effectively collect arthropods. In an alternative embodiment, there may be provided on carrier section 1102 a structure, such as a mechanical hold-down, for example an elastic band that is disposed over the wrapped cover section 1104 and that engages hooks 1110, 1110′ at opposite ends of the carrier section 1102, the mechanical hold-down configured to capture and hold the cover sheet 1104 when wrapped around the carrier section 1102, and configured to release the cover sheet 1104 after the arthropod mitigation device has been operated over an area of interest. In alternative embodiments, the mechanical hold-down may be a string or wire that is wrapped around or tied to one of hooks 1110, 1110′, stretched over the cover sheet 1104 and then tied to the one other of hooks 1110, 1110′. In yet another embodiment, the hold-down may be one or more thin ties, such as string, rubber bands, or zip ties, applied circumferentially around the carrier section 1102 and the cover sheet 1104 after the cover sheet 1104 is placed around the carrier section 1102.

In alternative embodiments, any of the carrier section 1002 of FIG. 10A, the carrier section 1008 of FIG. 10B, the carrier section 1020 of FIG. 10C and the carrier section 1102 of FIG. 11 may also be disposed of with the respective cover sleeve 1004 and cover sheet 1104, after a specific use or operation of the arthropod mitigation device.

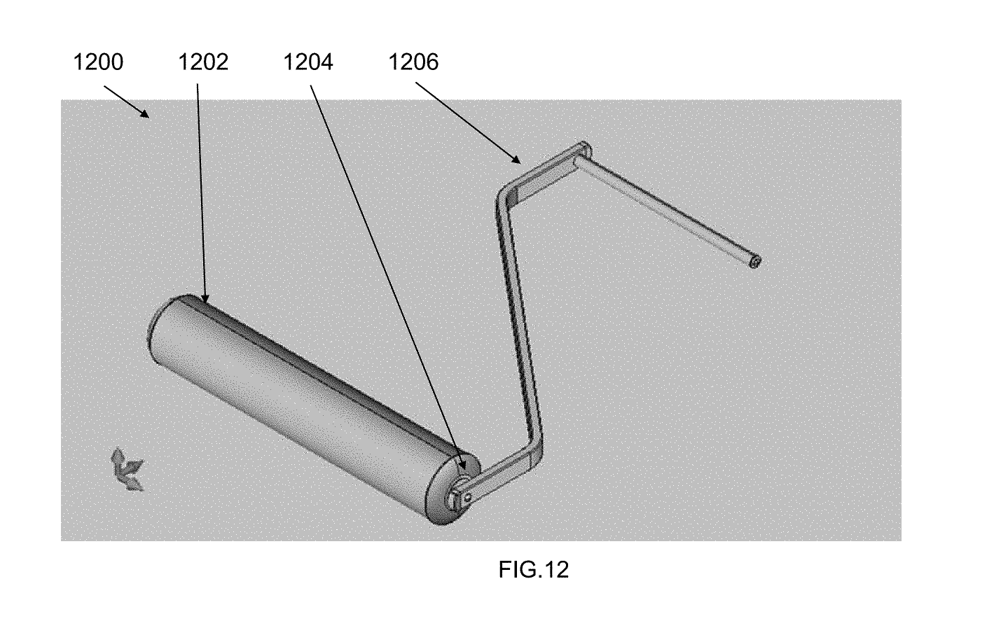

FIG. 12 is an illustration of an embodiment of an arthropod mitigation device 1200 according to principles of the invention. The arthropod mitigation device 1200 comprises a disposable portion including a carrier section 1204 and a cover section 1202, and also a handle 1206. When the carrier section 1204, the cover section 1202 and the handle 1206 are assembled in the configuration illustrated, a person can operate the device by pushing (or pulling) the handle so as to cause the carrier section 1204 and the cover section 1202 to pass over an area or region of interest so as to collect questing arthropods. When the operator is satisfied with the level of arthropod mitigation, at least the cover section 1202, and if desired, the carrier section 1204 of the disposable portion of the arthropod mitigation device 1200 may be disposed of. Optionally, the section or sections disposed of are placed in a refuse container.

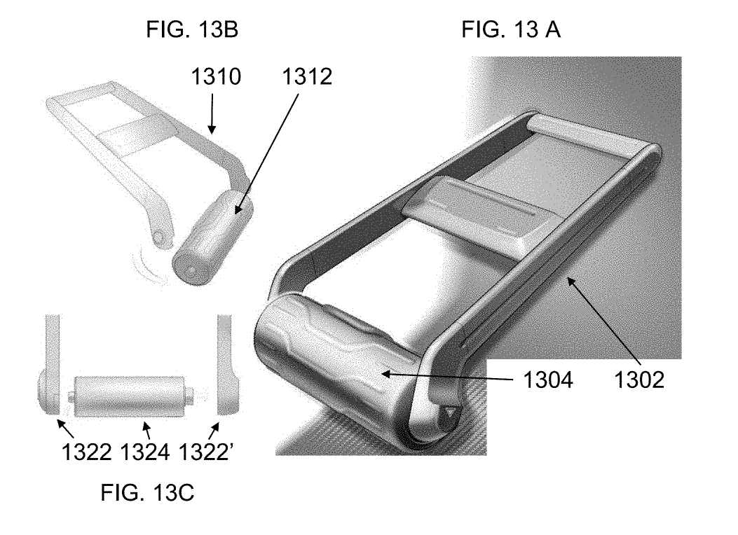

FIG. 13A is an illustration of another embodiment of an arthropod mitigation device according to principles of the invention. As illustrated in FIG. 13A, there is a handle 1302 and a disposable portion 1304. The disposable portion 1304 can be assembled using any of the various embodiments of a carrier section and a cover section as described hereinabove.

FIG. 13B is an illustration the disassembly of the arthropod mitigation device of FIG. 13A. In FIG. 13B, a handle portion 1310 is illustrated in partial assembly with a disposable portion 1312. For purposes of illustration, the handle portion 1310 may be the same as handle portion 1302, or they may be different, for example constructed of different materials (plastic in one instance, metal in another). The disposable portion 1312 can be assembled using any of the various embodiments of a carrier section and a cover section as described hereinabove.

FIG. 13C is an illustration of the mechanical relationship among parts of the arthropod mitigation device of FIG. 13A. In FIG. 13C, a connection portion 1322, 1322′ of handle portion 1302 is illustrated in exploded view with a disposable portion 1324. The disposable portion 1324 can be assembled using any of the various embodiments of a carrier section and a cover section as described hereinabove.

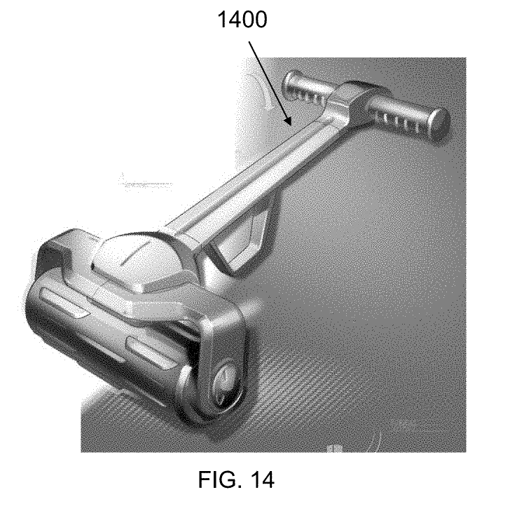

FIG. 14 is an illustration of still another embodiment of an arthropod mitigation device according to principles of the invention.

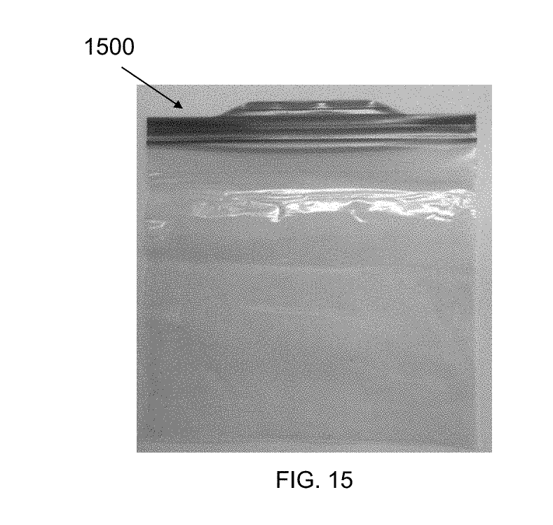

FIG. 15 is an image of a Ziploc® zip closure bag 1500. As is known, a zip closure bag includes interlocking ridges at the open edge, which may be interlocked by the application of pressure to the outside of the bag. When interlocked, the ridges serve to seal the bag.

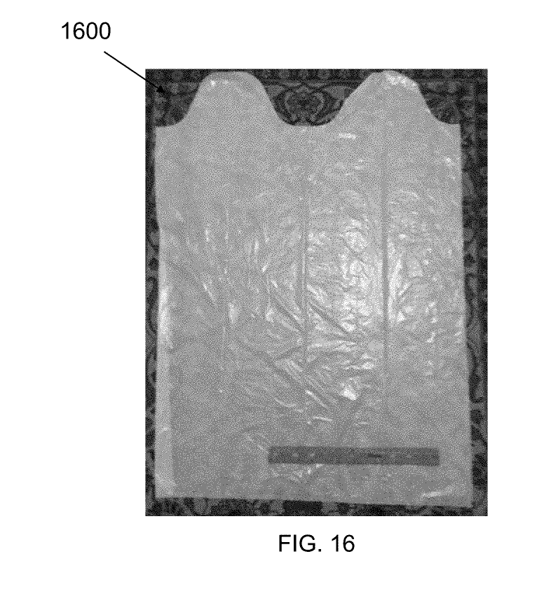

FIG. 16 is an image of a 13 gallon kitchen garbage bag 1600. The garbage bag shown is constructed of white plastic (although the color could be any color, or the bag could be clear plastic) and was placed on a dark background so that the bag is more easily visualized. The bag is a double layer of plastic material, which two layers are sealed together along the left and right sides and the bottom edge of the illustrated bag. After the bag is filled with a disposable section of the device, it may be closed by tying the “ears” (the curved segments at the top of the bag, of which only two of the four present are shown, the other two being beneath the two that are illustrated). Alternatively, the open end of the bag can be twisted into a “string” by compressing and twisting the material near the open end, and the “string” may be tied in a knot. In another alternative, after twisting the open end of the bag into a “string”, a tie may be tied around the “string.”

### Distinction of the Invention Over the Prior Art

Traditional tick collection methods often employ a technique referred to as “tick dragging”, whereby a cloth measuring approximately 1 meter by 1 meter, is used to “drag” along the surface of foliage in an attempt to exploit the arthropods “questing” behavior. The nature of “questing” is to facilitate the adherence to a potential host. However this behavior does not afford one the capacity to differentiate between an actual host, or a synthetic material that has the same physical characteristics of a preferred host. The ticks appendages are configured to establish a “snaring” action via tiny “hook like” tips at the ends of their appendages, which help to facilitate adhesion upon the surface of a host. Although this method of “dragging” has been shown to be an effective means of adhering ticks, its very application places the user in danger of becoming a potential host himself

In order to drag the cloth, the user either walks directly in front of the cloth, or off to one side. In either configuration, the user potentially places himself directly in the pathway of the ticks.

In the present invention, one can avoid this dilemma by “treating” the foliage (or mitigating the number of arthropods) before the user is required to walk through it. One such device is the “roller”, which is propelled by a user, who applies a force via a handle as the user walks behind the device. The roller's surface is further configured to possess a synthetic covering which mimics the arthropods preferred host. The roller reduces exposure of a user to the likelihood of acquiring an arthropod as a result of causing “adherence” of the tick to the synthetic roller prior to the operator passing through the foliage. In this manner, the foliage or grass is “treated” or “swept” prior to the user walking through the foliage or grass. Arthropods exposed to the synthetic material are “tricked” into believing that it is a suitable host, and as a result, will adhere themselves to the material, thereby reducing potential exposure to an operator.

The “rolling” action of the device further reduces the potential of friction, which the “dragging” method suffers from as it is pulled atop of foliage. By dragging a cloth, it is subject to “snaring” upon debris, such as sticks, for which can reduce its effectiveness. Additionally, the frictional force exhorted upon “clinging” ticks as a result of being dragged across foliage may result in the loss of some of the ticks. By applying a roller, the action reduces the likelihood of “snaring” debris as a result of its spinning action, rather than a frictional drag. The ease by which a user can operate the roller, combined with its reduction in exposure to ticks as a user passes through the foliage, make the roller a preferred collection model.

In each of the embodiments, the invention provides that advantage that the user need not come into contact with a surface that has not been treated to mitigate the number of arthropods.

In some embodiments, such as the various embodiments configured as a mechanical roller, the user can walk behind the roller, so that the surface is treated to mitigate the number of arthropods before the user contacts the treated surface. In some embodiments.

### DEFINITIONS

As used herein, the term “outdoor workers” is understood to include people who work for pay (that is, for monetary or other valuable compensation) out of doors, for example, in fields, in the woods, along highways, in gardens and parks, and in other outdoor venues, as well people who work or who recreate outdoors for their own account (that is, without being compensated monetarily for their efforts by another party), such as people who do garden work for pleasure, people who hike, camp, hunt and fish, and people who play sports.

Unless otherwise explicitly recited herein, any reference to an electronic signal or an electromagnetic signal (or their equivalents) is to be understood as referring to a non-volatile electronic signal or a non-volatile electromagnetic signal.

### Theoretical Discussion

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

Any patent, patent application, patent application publication, journal article, book, published paper, or other publicly available material identified in the specification is hereby incorporated by reference herein in its entirety. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. An arthropod mitigation device, comprising:
a handle; and
a disposable section configured to be removably attached to said handle, comprising;
a carrier section having a substantially cylindrical surface;
a cover section configured to be applied to said carrier section, said cover section when so applied to said carrier section configured to provide a substantially cylindrical surface that is attractive to an arthropod;
said arthropod mitigation device configured to be operated by a user so as to traverse by rolling a region of interest believed to harbor an arthropod, and to mitigate said arthropod therefrom by without the application of a chemical insecticide.

2. The device of claim 1, wherein said arthropod is one of a tick a mosquito, and a flea.

3. The device of claim 1, wherein said cover section is provided in a sleeve configuration.

4. The device of claim 1, wherein said cover section is provided in a sheet configuration.

5. The device of claim 4, wherein said cover section in sheet configuration comprises an attachment structure.

6. The device of claim 5, wherein said attachment structure is a selected from the group consisting of a hook and eye fastener, an adhesive, and an elastic band.

7. The device of claim 1, wherein said carrier section is configured to expand radially when subjected to a pressure.

8. The device of claim 7, wherein said pressure is selected from the group of a mechanical pressure, a pneumatic pressure and a hydraulic pressure.

9. A method of mitigating arthropods, comprising the steps of:
providing an arthropod mitigation device, comprising:
a handle; and
a disposable section configured to be removably attached to said handle, comprising;
a carrier section having a substantially cylindrical surface;
a cover section configured to be applied to said carrier section, said cover section when so applied to said carrier section configured to provide a substantially cylindrical surface that is attractive to an arthropod;
said arthropod mitigation device configured to be operated by a user so as to traverse by rolling a region of interest believed to harbor an arthropod, and to mitigate said arthropod therefrom by without the application of a chemical insecticide; and
rolling said arthropod mitigation device over said region of interest;
collecting said arthropod; and
disposing of at least said cover section of said disposable section;
thereby mitigating arthropods from said area of interest.

10. The method of mitigating arthropods of claim 9, further comprising the step of disposing of at least said cover section of said disposable section by placing at least said cover section in a refuse container.

11. The method of mitigating arthropods of claim 10, wherein said refuse container is selected from a zip closure bag and a garbage bag.

12. The method of mitigating arthropods of claim 10, wherein said refuse container comprises an insecticide.

13. The method of mitigating arthropods of claim 9, wherein said arthropod is one at least of a tick a mosquito, and a flea.

14. A method of providing an arthropod mitigation device in kit form, comprising:
a handle;
a disposable section configured to be removably attached to said handle, comprising;
a carrier section having a substantially cylindrical surface; and
a cover section configured to be applied to said carrier section, said cover section when so applied to said carrier section configured to provide a substantially cylindrical surface that is attractive to an arthropod;
said kit when assembled configured provide an arthropod mitigation device configured to be operated by a user so as to traverse by rolling a region of interest believed to harbor an arthropod, and to mitigate said arthropod therefrom by without the application of a chemical insecticide.

15. The method of providing said arthropod mitigation device in kit form of claim 14, wherein at least two of said handle, said carrier section, and said cover section are provided assembled to each other.

16. The method of providing said arthropod mitigation device in kit form of claim 14, wherein said cover section is provided in a configuration selected from a sleeve configuration and a sheet configuration.

17. The method of providing said arthropod mitigation device in kit form of claim 16, wherein said cover section in sheet configuration comprises an attachment structure.

18. The method of providing said arthropod mitigation device in kit form of claim 17, wherein said attachment structure is a selected from the group consisting of a hook and eye fastener, an adhesive, and an elastic band.

19. The method of providing said arthropod mitigation device in kit form of claim 14, wherein said carrier section is configured to expand radially when subjected to a pressure.

20. The method of providing said arthropod mitigation device in kit form of claim 19, wherein said pressure is selected from the group of a mechanical pressure, a pneumatic pressure and a hydraulic pressure.
